(19) United States
(12) Patent Application Publication
(10) Pub. No.: US 2005/0076837 A1
(43) Pub. Date: Apr. 14, 2005

(54) Conveyorized horizontal processing line and method of wet-processing a workpiece

(76) Inventor: Lorenz Kopp, Wohnsitz (DE)

Correspondence Address: Frank J Bonini Jr;Harding Earley Follmer & Frailey, Post Office Box 750, Valley Forge, PA, 19482-0750, US

(21) Appl. No.: 10/501,492

(22) PCT Filed: Feb. 20, 2003
(86) PCT No.: PCT/EP03/01742

(30) Foreign Application Priority Data
Mar. 5, 2002 (DE) 102 10 538.3

(51) Int. Cl. B05D 1/02; B05C 11/00

(52) U.S. Cl. 118/664; 118/668; 427/424; 118/671

(57) ABSTRACT

The problem confronting manufacturers of printed circuit boards (2) of differing thickness is that, as the current density increases and the diameter of the holes decreases, the treatment effect on various locations on the outer side of the boards and inside the holes becomes more irregular. To resolve this problem, a conveyorized horizontal processing line and a method of wet-processing printed circuit boards (2) is described. To manufacture the printed circuit boards (2), data about the thickness of the workpiece (2) are acquired before it enters the conveyorized processing line and are stored in a data memory, the workpiece (2) is conveyed through the conveyorized processing line and a structural component, which is provided with at least one transport member (3) for the workpiece (2) and with at least one processing facility (6) and which is disposed above the conveying path (100) in the conveyorized processing line, is adjusted in such a manner that the structural component is raised or lowered and/or pivoted relative to the conveying path as a function of the thickness of the respective one of the workpieces passing said structural component.

The invention relates to electrolytically treating, metal-plating and etching a workpiece such as a printed circuit board in conveyorized horizontal processing lines.

Conveyorized horizontal processing lines have proved to be efficient for wet-processing board-shaped or foil-shaped workpieces, printed circuit boards in particular, during the production thereof. In these lines, the workpiece travels from an entrance side to an exit side. Inside the line, the workpiece is contacted with an electrolyte fluid which may be a metallization fluid, an etch fluid or another processing fluid, depending on the treatment to be carried out.

For this purpose, conveyorized horizontal processing lines are substantially provided with process, e.g. plating, tanks which are filled with an electrolyte and accommodate the processing facilities such as flow nozzles, penstocks, anodes, heating devices and the like. A transport device conveys the parts to be processed in a horizontal or, in exceptional cases in a vertical, orientation through the line. When the workpiece is processed chemically, rollers are generally utilized for transport within the line, for electrolytic treatment, by contrast, wheels and/or clamps are preferred.

During electrolytic metallization, the workpiece is cathodically polarized. In this case, the counter electrodes are the anodes. During electrolytic etching, the workpiece is polarized anodically and the counter electrodes cathodically. For other electrolytic treatments, the workpiece may be polarized either anodically or cathodically. There are other methods of course, in which the workpiece is not treated electrolytically.

To place the workpiece in electric contact while it is conveyed through the line, clamps, tongs, screwed contacts and contact wheels may, i.a., be used. Both segmented and non-segmented contact wheels rolling on the edge of the board-shaped workpiece are known to be used as contacting members. A method of contacting by means of non-segmented contact wheels has been described in DE 32 36 545 A1 for example. There, the contact wheels roll on the edges of the boards while being shielded from the electrolytic chamber, thus transmitting the electric current onto the boards. Contact clamps removably take hold of one side of the boards, which, in this case, may be flat or not. Said clamps are capable of concurrently transporting and electrically contacting the boards. DE 36 24 481 A1 for example discloses an arrangement provided with such clamps: the arrangement serves to electrolytically deposit a metal, more specifically copper, onto printed circuit boards. An endless driven succession of individual clamps are used as transport members, said clamps firmly taking hold of the side edges of the printed circuit boards and moving them in the direction of transport within the arrangement.

In such lines, the upper transport members, transport rollers for example, are generally mounted so as to be vertically movable. DE 32 36 545 A1 for example indicates that a shaft carrying the transport roller is slidably carried in a vertically slotted hole provided in the side wall of the electrolytic tank. As the boards enter the line, they push the respective one of the upper rollers upward.

The upper processing facilities of the various processing stations are rigidly fastened to the plating tank or to a frame supporting said facilities. In the electrolytic plant described in DE 32 36 545 A1, the upper anodes are for example carried on anode holders which in turn are fastened between vertical boards.

The spacing between the processing facilities and the conveying path on which the objects are transported is generally chosen to be so great that even the thickest boards will not hit the lower edge of the facility.

It has been found that during electrolytic metallization the thickness of the metal coatings deposited onto the workpiece may vary to a lesser or greater degree. More specifically on the edges of the boards the metal coating deposited is thicker. In an effort to reduce the effect produced by differing board sizes on the coating thickness distribution, more specifically when metallization is carried out at a high current density, technically very complicated, adjustable, electrically isolating screens have been heretobefore used. EP 0 978 224 B1 discloses a device for the electrolytic metallization of printed circuit boards that has screens provided between the conveying path for the printed circuit boards, which lies in the plane in which the printed circuit boards are transported, and the anodes. Said screens are slidably carried in a direction which is oriented substantially parallel to the conveying path and substantially normal to the direction of transport. Depending on the size of the printed circuit boards, the screens are displaced in such a manner that the border regions of the printed circuit boards are partially shielded which permits to avoid increased metal deposition in these regions. The position of said screens is adjusted manually or automatically with respect to the printed circuit board, depending on the width of the printed circuit board, as viewed transversely to the direction of transport.

To increase the rate at which metal is deposited onto the workpiece, the treatment has to be carried out at a current density as high as possible. It has been found though that, as the current density increases, the coating thickness distribution both at various locations on the outer side of the boards and between the outer side of the board and the inside of the holes becomes more irregular. Hence, there is a limit to increasing the current density.

It is therefore the object of the present invention to avoid the disadvantages of known devices and methods and more specifically to find means by which the processing speed during electrolytic processes may be increased. It concurrently aims at achieving a uniform metal distribution on the outer sides of the boards and in the inside regions of the holes. It is also directed in making certain that the plant may be operated without any problem and interruption.

This objective is accomplished by the device according to claim 1 and by the method according to claim 13. Particularly advantageous embodiments of the invention are described in the subordinate claims.

The conveyorized horizontal processing line in accordance with the invention serves to wet-process workpieces, more specifically board-shaped or foil-shaped work, and first and foremost printed circuit boards and other electrical circuit carriers. The conveyorized processing line may be comprised of one single conveyorized processing module or of several such modules arranged in a row through which the workpieces are successively passed.

In accordance with the invention the line is comprised of the following facilities:
(a) at least one respective transport member for the workpiece located above and beneath a conveying path which extends in a horizontal direction of transport and in which the workpiece may be conveyed through the conveyorized processing line,
(b) at least one processing facility for the workpiece which is disposed above the conveying path and forms, together with the at least one transport member, one structural component above the conveying path,
(c) at least one adjusting device for the structural component, the at least one adjusting device being configured in such a manner that the structural component may be raised or lowered in a substantially vertical direction and/or may be pivoted, the structural component being, in the latter case, preferably pivotal about an axis that extends in a horizontal direction, substantially transverse to the direction of transport.

To treat the workpiece in the conveyorized horizontal processing line the following steps are performed:
(a) first, prior to feeding the workpiece into the processing line, data about the thickness of the workpiece are acquired and stored in a data memory;
(b) the workpiece is brought to the conveyorized processing line in one direction of transport and is passed through the conveyorized processing line on a conveying path;
(c) a structural component, which is comprised of at least one transport member for the workpiece and of at least one processing facility and which is disposed above the conveying path in the conveyorized processing line, is adjusted in such a manner that, as a function of the thickness of the respective workpiece being passed therethrough, the structural component is raised or lowered and/or pivoted relative to the conveying path, in the latter case the structural component being preferably pivoted about an axis extending in a horizontal direction, substantially transverse to the direction of transport.

As the processing facilities form, together with the transport members, a structural component that may be raised, lowered and/or pivoted relative to the conveying path on which the workpiece is transported, substantially even spacing may always be maintained between said structural component and the conveying path.

As the density of integration in the electric circuits increases, the diameter of the holes in the workpieces, more specifically in the printed circuit boards, must become increasingly smaller. Moreover, during electrolytic processes, the current density is being more and more increased in an effort to accelerate the treatment process and to thus permit to reduce the length of the line and, as a result-thereof, the expenditure. To meet these requirements, the spacing between the anodes and the surface of the workpiece may be reduced for example. The treatment process is simplified and the quality improved as a result thereof. The spacing between anode and cathode may be maintained from about 5 to 20 mm in order to reduce the peak effect on edges and pads of the workpiece during electrolytic treatment. Accordingly, if, in conventional lines, the spacing between the surface of the workpiece and the processing facilities is reduced, the differences in the spacing on the upper and lower side thereof proportionally increase depending on the thickness of the workpiece since the position of the lower processing facilities relative to the underside of the workpiece is fixed while the spacing of the upper surface of the workpiece from the upper processing facilities is not. The different spacing of the upper and lower anodes from the surfaces to be processed has an adverse effect on workpieces of differing thickness. Normally, two rectifiers regulate the current for each board side individually. This results in inconvenient quality differences on the two sides of the workpiece.

In view of these drawbacks experienced with the known devices and methods, namely that, more specifically when using a high current density during electrolytic treatment, differing treatment results are obtained at various locations on the surface of the printed circuit board and between the outer side of the printed circuit board and the inside of the holes, more uniform results, such as with respect to the thickness of the metal deposited, are achieved in maintaining substantially even spacing between the processing facilities and the surface of the printed circuit board. Such uniform results as they are obtained during electrolytic metallization are also achieved during electrolytic etching and with chemical (non electrolytic) treatment methods by always maintaining substantially even spacing between the feeding devices for the fluid processing means and the surface of the printed circuit board. The treatment yields a particularly good result when even spacing is maintained both between the counter electrodes and the surface of the printed circuit board and between the other processing facilities and the surface of the printed circuit board. In conventional lines, the spacing of the lower surface of the workpiece from the lower processing facilities is fixed. But, in treating workpieces of differing thickness, the spacing of the upper processing facilities from the upper surface of the workpiece varies as a function of the thickness thereof in this case.

To compensate for this effect, the processing facilities are combined into a structural component. By combining the processing facilities and the transport members to form one structural component, the spacing mentioned may be kept substantially even since this provision permits to adjust the position of the structural component to the thickness of the workpiece by having transport members configured as rollers or wheels for example rolling on the upper outer side of the workpiece so that the height of the structural component relative to the height of the upper surface of the workpiece is automatically adjusted. In accordance with the present invention there is provided an adjusting device by means of which the structural component may be raised, lowered and/or pivoted relative to the conveying path depending on the thickness of the respective one of the workpieces being passed therethrough. The height of the structural component is thus automatically or manually adjusted independent of the transport members rolling on the surface of the workpiece.

If the work to be processed consists for example in thin printed circuit boards or in printed circuit foils with minute holes or blind holes and with finest circuit traces, the spacing between the processing facilities and the upper surface of the workpiece may be too great in conventional lines since the spacing must be set in such a manner that thick boards may also be processed. In practice, the thickness of the boards or foils ranges from 0.05 mm to 10 mm. If boards of for example 10 mm thick are also to be processed, the spacing must be at least such that these boards are also allowed to pass through the processing facilities without hitting them. In this case, flow nozzles, disposed for example above the conveying path, are no longer capable of rinsing fine holes in thin boards or foils thoroughly enough so that scrap may be generated during production.

This problem is resolved by the processing line and by the method of the invention.

The invention provides another advantage: if thin material, more specifically foils, is to be transported, it is often advantageous to reduce the diameter of the transport rollers in order to prevent the foils from adhering on the rollers. Disturbances however proved to often disrupt operation of the line when these smaller rollers are to convey thick material because the rollers can readily be damaged by the sharp-edged printed circuit boards or because the available advance force that pushes the printed circuit boards forward does not suffice to lift these smaller rollers onto the thicker boards. In this case, congestion of the boards may readily occur. Using the line and the method in accordance with the present invention, the quality of the workpiece is thus improved and damage to the transport rollers is avoided.

Wet-processing is to be construed herein as any treatment by means of which workpieces are treated using fluid or gaseous processing means, more specifically as electrolytic treatment processes such as electrolytic metallization and etching as well as chemical treatments such as electroless and charge transfer metallization methods, chemical etching methods as well as other processing methods such as cleaning, conditioning and activating methods.

When the workpieces are treated electrolytically, the processing facilities may be the counter electrodes, meaning anodes or cathodes, or facilities for delivering or removing processing fluid, more specifically processing liquid, to the workpieces such as jet nozzles, flow nozzles, spray nozzles, suction nozzles for fluids and blast and suction nozzles for gases as well as additional guide elements for thin workpieces. Together with the transport members, one or several such processing facilities may form the structural component mentioned. For this purpose, the processing facilities and the transport members are structurally joined together in an appropriate manner.

The transport members of preference are transport rollers or transport rolls disposed on an axis. Other types of transport members are of course also conceivable such as for example laterally guided clamps or trailers.

In a preferred embodiment of the invention there is provided at least one sensor for determining the thickness of the workpiece. The sensors may be conventional measuring sensors, for example structural members that determine the thickness by scanning using measuring rolls, photosensitive devices, laser measuring devices and the like. The thickness of the respective one of the workpieces entering the line is determined by means of the sensor and serves to trigger the adjusting device for the structural component. Once the thickness of a board or a foil within the processing plant has been ascertained by means of the sensor, the height of the structural component may be adjusted in such a manner that the spacing of the structural component from the surface of the board or foil remains constant as the board is conveyed past the structural component. Alternatively, it is possible to store the thickness of the boards in a previously created master file of articles in a plant control and to retrieve them when appropriate.

Besides the parameter of the board thickness, the computation of the height of the upper structural component which is to be adjusted includes also other parameters of the workpiece, though. In the case of thick boards with very small holes, the height of a structural component with flow nozzles for example may be adjusted to be slightly lower than usual, i.e., with boards having greater hole diameters, in order to still further enhance the flow of the processing fluid therethrough. This, of course, is only possible if the boards are very flat. Otherwise, there is the risk that the workpiece slightly touches the upper facilities and is slowed down as a result thereof so that congestion of the boards occurs which may result in scrap material being generated during production.

The sensor may be disposed directly in front of the structural component, as viewed in the direction of transport, so that as soon as the thickness has been determined, the adjusting device for the structural component may be triggered accordingly. To dispose the sensor in immediate proximity to the very structural component may be disadvantageous if in this case the sensor were located inside the processing liquid since the thickness would be difficult to measure. Therefore, the at least one sensor is preferably arranged in the entrance region of the conveyorized processing line for the workpiece, outside of the wet-processing stages.

The data acquired by the sensor may be entered in a data memory in particular. For this purpose, said data are converted into control signals for example and the control signals are then transmitted from said data memory, preferably at an appropriate instant of time, to trigger the adjusting device for raising, lowering and/or pivoting the structural component. More specifically, in order to raise, lower and/or pivot the structural component to match the thickness of the respective one of the workpieces being passed there through under these conditions, there are further provided a logic for tracking the workpiece in the conveyorized processing line and a control system for the at least one adjusting device for the structural component. For this purpose, the actual location of the workpiece within the conveyorized processing line is permanently logically tracked and the structural component is raised, lowered and/or pivoted as a function of the location thereof.

Thanks to the logic for tracking of the workpiece and to the control system, the height of the structural component is adjustable to the thickness of the workpiece conveyed past the structural component. For this purpose, a set point for the height adjustment of the structural component may be determined by measuring the thickness of the workpiece as it is being brought to the conveyorized processing line and then, the actual position of the workpiece passing through the conveyorized processing line may be calculated or otherwise determined.

The logic for tracking the workpiece may for example be an arithmetical unit that computes the time at which the workpiece should be conveyed past the structural component from the speed at which the workpiece is conveyed through the line, from the spacing between the sensor and the structural component and from the time at which the workpiece enters the line. This logic may also be comprised of additional sensors which, at certain sites in the line, detect individual workpieces presently located within their range or a momentaneous gap between two workpieces. Other tracking systems, more specifically a combination of these variants, may also be thought of.

According to the thickness of the workpiece conveyed through the line, the structural component is raised, lowered and/or pivoted through the control signals. Suited adjusting devices that move the structural component by means of corresponding adjusting drives are provided for this purpose. The adjusting device may be configured in various ways: it may for example be a motor-driven eccentric shaft, a motor-driven threaded spindle, a hydraulically or pneumatically driven adjusting device or a motor-driven sheathed cable.

In a preferred embodiment, the adjusting device is driven hydraulically. In this case, the energy for driving the adjusting device may be tapped in the form of auxiliary energy from at least one pump which is provided on the conveyorized processing line for supplying the jet nozzles, the spray nozzles or the flow nozzles and/or for circulating the bath liquid to ensure the circulation of the liquid in the bath. Therefore, further auxiliary units need not be provided for in order to drive the adjusting device. In using the energy of these pumps, other sources of energy may be dispensed with so that capital expenditure and energy costs are saved. In this case, the structural component may be raised by means of chemical resistant bellows or lifting cylinders or the like. The height of the lift may for example be achieved by means of overflows that are provided on the hydraulic lifting facilities and that are variable in height and controlled by the transport rollers and/or by means of height limiting stops that are adjustable by the control unit of the line.

In a particularly preferred embodiment of the invention, the structural component is pivoted, as the workpiece is conveyed through the conveyorized processing line, in such a manner that the height of that region of the structural component that faces the entrance side of the line is adapted first to the thickness of an entering workpiece and that the structural component is pivoted again as the workpiece is conveyed further so that the height of the region of the structural component facing the exit side of the line is now adjusted to the thickness of said conveyed workpiece. This provision permits to largely avoid the problem experienced when the boards or foils change from thick to thin or from thin to thick. As a result thereof, the height of the structural component is adjusted to differing thicknesses of consecutive boards or foils that are encountered at the same time within the range of the structural component. For this purpose, separate adjusting devices that are triggered and driven separately and independent of one another are required.

Both the transport members in the structural component above the conveying path and those located beneath the conveying path are preferably elongated and disposed substantially perpendicular to the direction of transport and parallel to the conveying path. The transport members are thus capable of taking very evenly hold of the workpiece and of transporting it.

In order to further make sure that the structural component is movable in height, the transport members disposed above the conveying path are guided in lateral long hole bearings mounted outside of the conveying path. On the one hand, safe drive of the transport members is thus guaranteed. On the other hand it is made certain that the transport members, and as a result thereof the structural component, are guided in vertical guides.

In configuring the lateral guides for the transport members in a suitable manner, the height of the transport members may also be adapted to the thickness of the workpiece in such a way that the force exerted by the transport members onto the respective workpiece being conveyed therethrough is limited. For this purpose, a bottom catch is provided for the shafts of the transport members guided in the lateral long holes. More specifically, the height of the bottom catch may be additionally adjusted to the thickness of the workpiece being conveyed past the structural component. As a result thereof and in connection with supporting springs located beneath the bottom catches, the transport members for example do not rest with their entire weight on the surface of the workpiece so that damage to the surface of the workpiece is avoided.

The invention will be explained in greater detail with reference to the exemplary embodiments described herein after.

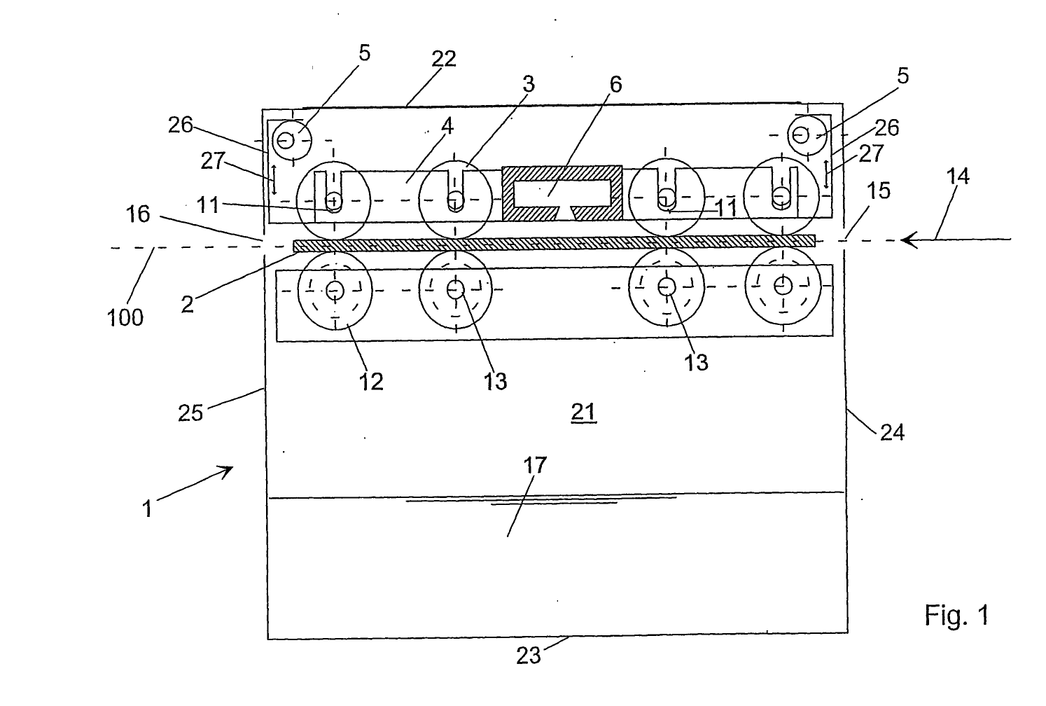

FIG. 1 is a sectional side view schematic of a processing module of a first embodiment of the conveyorized horizontal processing line;

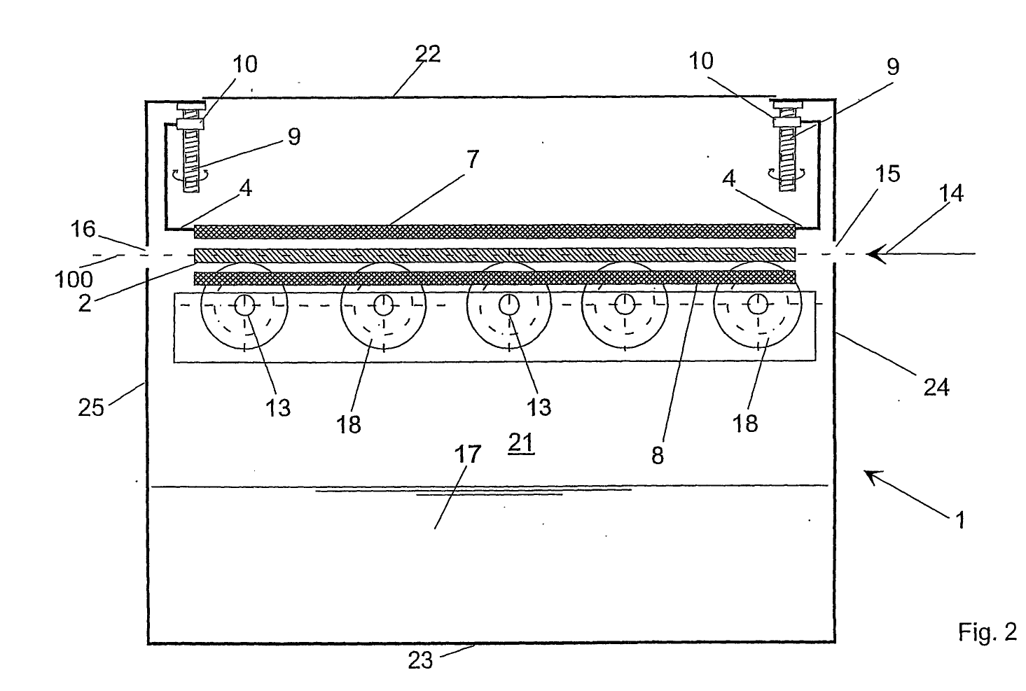

FIG. 2 is a sectional side view schematic of a processing module of a second embodiment of the conveyorized horizontal processing line;

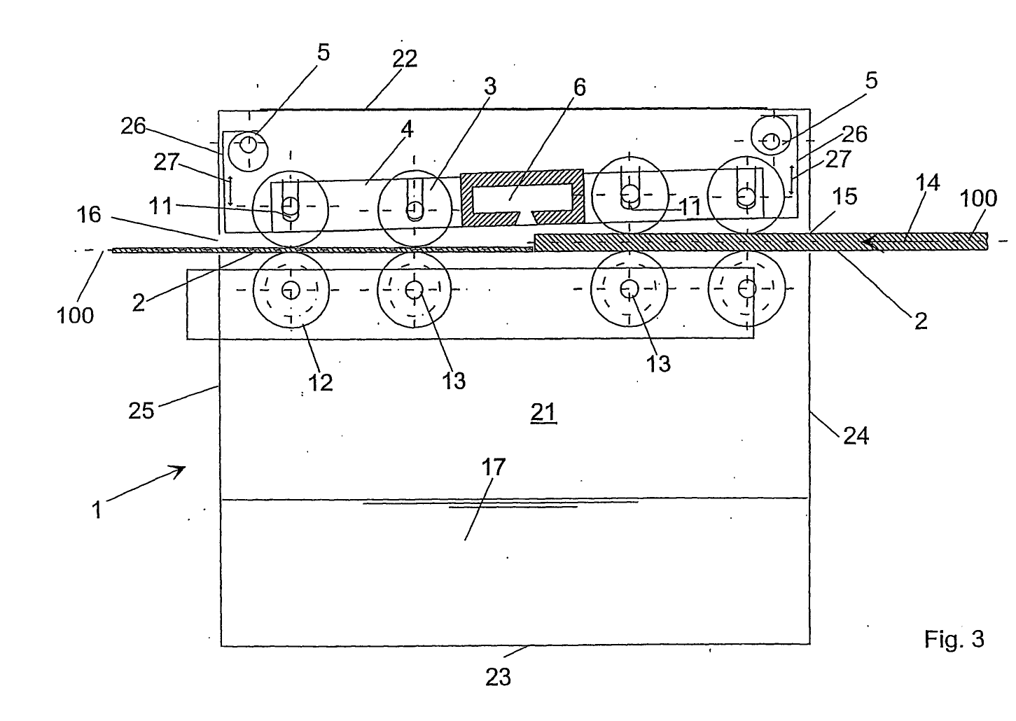

FIG. 3 is a sectional side view schematic of a processing module of a third embodiment of the conveyorized horizontal processing line.

Conveyorized horizontal processing lines in accordance with the invention are generally comprised of several different processing modules through which the flat workpieces, referred to as printed circuit boards or boards herein after, are conveyed.

FIG. 1 illustrates one single conveyorized processing module for horizontal chemical treatment with an upper carrying frame which is height adjustable through eccentric axes.

On a horizontal conveying path 100, the printed circuit boards 2 are conveyed by way of lower transport rollers 12 and upper transport rollers 3 from one end of the module to the other end of the module at uniform speed.

As shown in FIG. 1, one single module is comprised of a plating tank 1 that receives the processing liquid in the liquid basin 17. The plating tank 1 is provided here with two side walls 24, 25 and with a front and a rear wall, the rear wall 21 only being illustrated in FIG. 1. A cover 22 and a tank bottom 23 are further provided. On the side wall 24 located on the entrance side there is provided a horizontal slot 15 through which the printed circuit boards 2 are introduced into the module in the direction of transport indicated by the arrow 14. On the side wall 25 located on the exit side, a horizontal slot 16 is also provided through which the boards 2 exit the module.

For chemical treatment, the processing fluid is delivered to the boards 2 through pumps and pipes that are not illustrated herein and through processing facilities, in the present example through an upper flow nozzle 6 that has been illustrated herein in a sectioned view for better illustration.

The flow nozzle 6 is fastened to a vertically movable carrying frame 4. The height of the carrying frame 4 and of the processing facility 6 fastened thereon is adjusted through actuating drives that have not been illustrated herein and through eccentric shafts 5. For this purpose, the carrying frame 4 is carried on eccentric shafts 5 by way of carrying members 26, said eccentric shafts extending substantially transverse to the conveying path and parallel to the side walls 24 and 25. Upon rotation of the eccentric shafts 5, the carrying members 26 and, as a result thereof, the carrying frame 4 are moved in a vertical direction in the direction indicated by the arrows 27.

A bearing arrangement 11 for the upper transport rollers 3 in the form of long holes is also provided in the carrying frame 4; This bearing 11 in the long holes is advantageous in spite of the height adjusting device. The height of the lowest bearing point of the bearing arrangement 11 is chosen to be such that, on the one hand, the rollers 3 have to be pushed upward by only some decimillimeters when a printed circuit board 2 is entering the line in order to keep the thrust to be exerted by the board low, and that, on the other hand, they are capable of reliably pushing the board downward by their own weight or through the force of a spring, even against the thrust of a jet nozzle possibly disposed at the bottom (this has not been provided in the exemplary embodiment represented herein). The lower transport rollers 12 are carried in a rigid transport roller bearing 13.

Before a board 2 enters the respective one of the processing modules, the eccentric shafts 5 are rotated to the left or to the right through a control unit of the line (not shown) and through drives that have not been illustrated herein either so that the height of the upper flow nozzle 6 is changed through the carrying frame 4 in such a way that the spacing between the lower surface line of the upper transport rollers 3 and the printed circuit board 2 getting nearer always remains the same in spite of the differing thicknesses of the boards. Concurrently, the height of the upper flow nozzle 6 is also changed according to the thickness of the boards 2. This provision makes it possible to keep the diameter of the upper transport rollers 3 small in order to reduce the risk that foil material adheres thereon during treatment, to save valuable material for the manufacturing of the rollers 3 and to insure safe transport of the printed circuit boards 2.

If the adjusting device 4, 5, 26 did not raise the roller bearings 11 when a printed circuit board 2 hits the transport rollers 3, the force the printed circuit boards 2 would have to exert by the advance motion of the boards 2 in order to raise the rollers 3 would be much higher because of the less favorable angle of pressure between the edge of the board and the transport roller 3. With thicker boards 2, this would often lead to congestion of the boards in the module and, as a result thereof, to disturbances and possibly to scrap generation during production.

The height required for the lifting device 4, 5, 26 is inferred from the thickness of the boards. The thickness of the boards may be determined by means of a sensor (not shown herein) before the boards 2 enter the line or during loading thereof. The control signal determined for a certain board 2 as a function of the thickness thereof is transmitted to the adjusting device 4, 5, 26 at a certain instant so that the adjusting drive is triggered. For this purpose, the actual position of the board 2 as it is being passed through the entire line is calculated on the basis of the transport velocity and the instant of time at which the board 2 is conveyed past the structural component of concern is determined. Then, the height of the upper carrying frame 4 is adjusted, together with the transport rollers 3 and the processing facility 6, to match the time.

If the thickness of the boards changes in greater time intervals only, in mass production for example, the upper carriers of the structural component may also be adjusted by hand. In this case, the control unit signals, through corresponding signaling means provided in the line, to the operating staff the right instant of time for adjustment and the set point, the staff then executing the corresponding adjustment by hand.

For the sake of simplicity of the illustration, lower processing facilities, which are adjusted to a fixed level, are not shown in FIG. 1.

FIG. 2 illustrates a conveyorized horizontal processing module in a second embodiment.

Again, one single module is comprised of a plating tank 1 that receives the processing liquid in the sump for the liquid 17. The plating tank 1 is also provided with two side walls 24, 25 and with a front and a rear wall, the rear wall 21 only being illustrated. A cover 22 and a tank bottom 23 are further provided. On the side wall 24 located on the entrance side there is provided a horizontal slot 15 through which the printed circuit boards 2 are introduced into the module in the direction of transport indicated by the arrow 14. On the side wall 25 located on the exit side, a horizontal slot 16 is also provided through which the boards 2 exit the module.

In this exemplary embodiment, insoluble anodes 7, 8 are located above and beneath the conveying path 100 for the boards 2. In this example, the current is supplied to the boards 2 by contact clamps (not shown) provided on the side edge of the boards 2. Alternatively, it is possible to use cathodically polarized, electrically conductive contact rollers which are disposed above and beneath the workpiece 2 and which are often disposed outside of the processing liquid to avoid the risk of being metallized.

The spacing of the lower anodes 8 from the boards 2 is fixed and the same for all of the board thicknesses because the lower transport wheels 18 are carried on a fixed level, thus determining the position of the underside of the boards 2. In this module, the boards 2 are not conveyed by rollers, but by narrow transport wheels 18 as rollers would screen the boards 2 from the electric field to too great an extent. Through slots in the lower anodes 8, the transport wheels 18 extend into the electrolytic partial cell between the conveying path 100 and the lower anode 8.

The spacing between the upper anode 7 and the upper side of the printed circuit boards 2 is changed according to the thickness of said boards 2 by way of a carrying frame 4, spindle nuts 10 and by rotating the threaded spindles 9 using drives that have not been illustrated herein. If the thick boards 2 were produced without adjusting this spacing, the latter would be smaller on the top than during the production of thin boards or foils 2 so that the cathodic current density would locally differ, which might result in burns in the metal deposition as the peak effect of edges and pads would differ greatly with different spacings between anode and cathode. If the spacing between anode and cathode in the cell is fixed, and if, as a result thereof, the current flow in the electrolyte is for example set to 10 mm, the upper spacing between anode and cathode obtained without adjustment of the upper anode 7 is 9.5 mm with a board thickness of 0.5 mm. If, by contrast, the board is a multilayer with a thickness of 5 mm, the top spacing is only 5 mm and is thus approximately 50% smaller than the lower spacing. This difference cannot be tolerated.

By raising the upper anodes 7 as a function of the thickness of the boards 2 as they enter the module, quality differences and, in extreme cases, scrap generation during production are reliably avoided.

FIG. 3 shows another preferred embodiment of the conveyorized processing line according to the invention. As far as the various elements of the line are concerned, the reader is referred to the description made of FIG. 1. Like elements bear the same reference numerals. In this case, the end of the carrying frame 4 located on the entrance side and that located on the exit side can be raised, lowered or pivoted independent of each other. Accordingly, it is made certain that the spacing of the upper surface of the printed circuit board from the processing facilities, the flow nozzle 6 in the present case, will be maintained as even as possible as thick boards 2 take the place of thin boards 2 or vice versa.

For this purpose, before the boards 2 enter the line, the height adjusting device 4, 5, 26 located on the entrance side, on the right side in FIG. 3, is actuated first. Once the first board 2′, which may be very thin for example, has traveled about half the length of the carrying frame 4, the adjusting device 4, 5, 26 located on the exit side, on the left side in FIG. 3, is actuated. If the following board 2 is thicker, the right adjusting device 4, 5, 26 is again actuated in such a manner that the carrying frame 4 is raised on the entrance side. As a result thereof, the structural component, together with the flow nozzle 6 and the transport rollers 3, which are firmly joined together through the carrying frame 4, is permanently pivoted about an axis extending in the horizontal direction transverse to the conveying path 100 as a function of the thickness of the respective printed circuit board 2 being passed therethrough.

This pivot motion of the structural component renders dummy boards or gaps in the production flow superfluous when boards 2 with a certain thickness are replaced by boards 2′ with a very different thickness. If a thin board 2′ is followed by a thick board 2, it would be impossible, but for the separate adjusting devices 4, 5, 26, for the raised rollers 3 to hold and convey the thin boards 2′ still remaining in the module on the exit side as thick boards 2 are entering the line. Thus however, only the transport rollers 3 located on the entrance side are raised according to the now entering thicker boards 2 and the still lower positioned transport rollers 3 on the exit side are still capable of: securely holding the thinner boards 2′.

Although preferred embodiments of the invention are described herein in detail, it will be understood by those skilled in the art that variations may be made thereto within the scope of the appended claims. This includes that any combination of the features according to the present invention disclosed herein is incorporated as to be disclosed in this application as well.

Listing of Numerals

1 plating tank
2, 2′ workpiece, (printed circuit) board
3 upper transport rollers
4 carrying frame
5 eccentric for the height adjustment of the carrying frame 4
6 height adjustable upper flow nozzle
7 insoluble upper anode
8 insoluble lower anode
9 threaded spindle for the height adjustment of the carrying frame 4
10 spindle nut
11 top transport roller bearing
12 lower transport rollers
13 lower rigid transport roller bearing
14 direction of passage of the workpiece 2
15 entrance slot
16 exit slot
17 processing liquid, sump for the liquid
18 transport wheels
21 rear side wall of the line module
22 cover of the line module
23 bottom of the line module
24 entrance side wall of the line module
25 exit side wall of the line module
26 carrying member
27 direction of motion of the structural component
100 conveying path for the printed circuit boards 2.

1. A conveyorized horizontal processing line for wet-processing a workpiece (2) having the following facilities: (a) at least one respective transport member (3; 12,18) for the workpiece (2) located above and beneath a conveying path (100) which extends in a horizontal direction of transport (14) and in which the workpiece (2) may be conveyed through the conveyorized processing line; (b) at least one processing facility (6) for the workpiece (2) which is disposed above the conveying path (100) and forms, together with the at least one transport member (3), one structural component above the conveying path (100); (c) at least one adjusting device (4; 9, 10; 5, 26) for the structural component, the at least one adjusting device (4; 9, 10; 5, 26) being configured in such a manner that the structural component may be raised or lowered in a substantially vertical direction and/or may be pivoted.

2. The conveyorized processing line according to claim 1, wherein means (4; 9, 10; 5, 26) are provided by means of which the spacing of the structural component from the workpiece (2) conveyed past said structural component may always be maintained substantially even.

3. The conveyorized processing line according to claim 1, wherein at least one sensor is provided to determine the thickness of the workpiece (2).

4. The conveyorized processing line according to claim 3, wherein the at least one sensor is disposed in the entrance region where the workpiece (2) enters the conveyorized processing line.

5. The conveyorized processing line according to claim 3, wherein a memory is provided for the data concerning the thickness of the workpiece (2).

6. The conveyorized processing line according to claim 1, wherein a logic for tracking the workpiece (2) in the conveyorized processing line and a control system for the at least one adjusting device (4; 9, 10; 5, 26) for the structural component are provided so that, thanks to the logic for tracking the workpiece (2) and to the control system, the height of the structural component is adjustable to the thickness of the workpiece (2) conveyed past said structural component.

7. The conveyorized processing line according to claim 1, wherein the at least one adjusting device is selected from the group consisting of a motor-driven eccentric shaft (5), a motor-driven threaded spindle (9), a hydraulically or pneumatically driven adjusting device and a motor-driven sheathed cable.

8. The conveyorized processing line according to claim 7, wherein auxiliary energy for hydraulically driving the at least one adjusting device may be tapped from at least one pump which is provided on the conveyorized processing line for supplying jet nozzles, spray nozzles or flow nozzles (6) and/or for circulating the bath liquid to ensure the circulation of the liquid in the bath.

9. The conveyorized processing line according to claim 1, wherein the at least one processing facility is selected from the group comprising anodes, cathodes, jet nozzles, flow nozzles (6), spray nozzles and suction nozzles for processing fluid and blast and suction nozzles for gases as well as additional guide elements for thin workpieces (2).

10. The conveyorized processing line according to claim 1 any one of the previous claims, wherein the at least one transport member (3; 12, 18) is configured to have an elongated shape and extends in a horizontal direction, substantially transverse to the direction of transport (14).

11. The conveyorized processing line according to claim 10, wherein the at least one transport member (3) disposed above the conveying path (100) is guided in lateral long hole bearings (11) disposed outside of the conveying path (100).

12. The conveyorized processing line according to claim 1, wherein the at least one transport member is selected from the group comprising transport rollers (3; 12) and of transport rolls (18) mounted on an axis.

13. A method of wet-processing a workpiece in a conveyorized horizontal processing line involving the steps of
(a) first acquiring data about the thickness of the workpiece and storing them in a data memory, prior to feeding the workpiece (2) into the processing line,
(b) bringing the workpiece (2) to the conveyorized processing line in one direction of transport (14) and passing it through the conveyorized processing line on a conveying path (100),
(c) adjusting a structural component, which is comprised of at least one transport member (3; 12,18) for the workpiece (2) and of at least one processing facility (6) and which is disposed above the conveying path (100) in the conveyorized processing line, in such a manner that, as a function of the thickness of the respective workpiece (2) being passed therethrough, the structural component is raised or lowered and/or pivoted relative to the conveying path (100).

14. The method according to claim 13, wherein the spacing of the structural component from the workpiece (2) conveyed past said structural component is always maintained substantially even.

15. The method according to claim 13, wherein the thickness of the workpiece (2) is determined by at least one sensor as it enters the conveyorized processing line.

16. The method according to claim 13, wherein the data about the thickness of the workpiece (2) are converted into control signals and wherein said control signals are transmitted to trigger at least one adjusting device (4; 9, 10; 5, 26) for raising, lowering and/or pivoting the structural component.

17. The method according to claim 13, wherein the actual location of the workpiece (2) in the conveyorized processing line is permanently logically tracked and wherein the structural component is raised, lowered or pivoted as a function of said location.

18. The method according to claim 13, wherein the structural component is raised, lowered and/or pivoted by way of at least one adjusting device (4; 9, 10; 5, 26) which is driven by means of an actuating drive and is selected from a group comprising motor-driven eccentric shafts (5), motor-driven threaded spindles (9), hydraulic drives, pneumatic drives and motor-driven sheathed cables.

19. The method according to claim 13, wherein auxiliary energy for hydraulically driving the at least one adjusting device (4; 9, 10; 5, 26) is tapped from at least one pump which is provided on the conveyorized processing line, said pump supplying the jet nozzles, the spray nozzles or the flow nozzles (6) and/or serving to circulate the bath fluid to ensure the circulation of the fluid in the bath.

20. The method according to claim 13, wherein a set point for the height adjustment of the structural component is determined by measuring the thickness of the workpiece (2) as it is being brought to the conveyorized processing line and by logically tracking the workpiece (2) as it is being conveyed through the conveyorized processing line.

21. The method according to claim 13, wherein, as the workpiece (2) is being conveyed through the conveyorized processing line, the structural component is pivoted in such a manner that the height of the region of the structural component located on the entrance side of the line is adjusted to the thickness of a new workpiece (2) entering the line and wherein, as the workpiece (2) is conveyed further, the structural component is again pivoted in such a manner that the height of the region of the structural component located on the exit side of the line is now adjusted to the thickness of said entering workpiece (2).

22. The method according to claim 13, wherein the height of the structural component is adjusted to the thickness of the workpiece (2) in such a manner that the force exerted by the at least one transport member (3) onto the respective one of the passing workpieces (2) is limited.
